(19) United States
(12) Patent Application Publication
(10) Pub. No.: US 2007/0199298 A1
(43) Pub. Date: Aug. 30, 2007

(54) Sealed chain joint structure

(76) Inventor: Kensei Sakai, Ishikawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/702,600

(22) Filed: Feb. 6, 2007

(30) Foreign Application Priority Data
Feb. 6, 2006 (JP) 2006-28330

(51) Int. Cl. F16G 13/00

(52) U.S. Cl. 59/78.1

(57) ABSTRACT

To provide a sealed chain joint structure that connects both ends of the sealed chain by fitting a seal ring concentrically around a pin in a gap formed between an inner plate of an inner link and an outer plate of an outer link, in which a coupling plate can be easily installed using ordinary tools. A coupling link joins together inner links of both ends, a coupling pin passed through a bush hole projects from the outer plate, a tip portion of the coupling pin is a stepped tip portion of reduced diameter, and a ring groove is formed in an outer periphery of the stepped tip portion. A separate seal ring is fitted to the ring groove and the stepped tip portion protruding from an opposite side of the inner link is inserted into a hole to mount the coupling plate, and a clip engages a clip groove formed in the tip of the stepped tip portion and installed.

### BACKGROUND OF THE INVENTION

1. Field of the Invention

The present invention relates to joint structure in the case in which both ends of a sealed chain are connected and joined together so as to be endless. Although the sealed chain noted here is a chain of a type that reduces frictional wear stretching by filling the spaces between the pins and the bushes with grease and interposing seal rings between the inner plates and outer plates of the roller chain, the present invention is not limited to roller chains used for power transmission but also includes conveyer chains as well.

2. Related Art

As shown in FIG. 5, in a roller chain, inner links (a) and outer links (b) are alternately connected. The inner link (a) is constructed such that bushes (d), (d) are pressed into two holes in two inner plates (c), (c) spaced a predetermined interval apart, with rollers (e), (e) rotatably axially supported on the outer periphery of the bushes (d), (d). In addition, the outer link (b) is constructed such that two pins (g), (g) are press-fitted into two holes in two outer plates (f), (f) spaced a predetermined interval apart

Then, the pin (g) of the outer link (b) fits into the bush hole in the inner link (a) so as to be rotatable. Therefore, the inner links (a), (a)—and the outer links (b), (b)—can bend in a state of mutual connection, and can be wound around a sprocket to transmit motive power. It should be noted that although with a roller chain the inner links (a), (a)—and the outer links (b), (b)—are tied together and extend in a straight line, when wound around both sprockets both ends are joined together so as to be endless.

In order to join together both ends of a roller chain so as to be endless, coupling links are used and the inner links of both ends are joined together. Such a coupling link passes two coupling pins projecting from the outer plate (f) through the bush holes in the inner links (a), (a) of both ends, and the ends of the coupling pins protruding from the opposite sides of the inner links (a), (a) are press-fitted into holes in a coupling plate that corresponds to an outer plate and caulked. A special connecting tool is used for this type of connecting work, by which an endless roller chain adjusted to a predetermined length is made.

When connecting the ends of a roller chain so as to be endless as described above, or when cutting such a roller chain, special cutting/connecting tool is used. The “Chain Connecting/Cutting Apparatus” according to JP-Y-57-33985 is a tool previously acquired by the applicant. At the same time, a joint structure that passes coupling pins through the bush holes in the inner links (a), (a), fits the protruding coupling pins into holes in the coupling plate, and holds them in place with a clip so that they do not detach when connecting the roller chain is also known.

FIG. 6 shows a joint structure in which a coupling plate (j) is held in place by a clip (h) so as not to detach loose. With this type of joint structure, a roller chain can be connected using a simple tool, without using a special chain connecting/cutting apparatus. Specifically, coupling pins (i), (i) of the coupling link are inserted into the holes in a coupling plate (j) and a clip (h) is installed on the outside of the coupling plate (j). Clip grooves are provided on the ends of the coupling pins, and the clip (h) engages with these clip grooves and is installed. In the case of this joint structure that uses the clip (h) also, the coupling pins (i) are pressed lightly into the holes in the coupling plate (j) or in some cases simply inserted therein leaving a slight clearance.

However, as a roller chain that reduces stretching, one that fits a seal ring around the pin between the outer plate and the inner plate is known. Therefore, by filling the bush hole with grease and assembling, such grease does not escape, thereby preventing frictional wear between the bush hole and the pin and enabling stretching to be reduced. Consequently, with this type of roller chain (sealed chain), the joint structure cannot be one that inserts the coupling pins without force and holds them with a clip.

Specifically, if the coupling pins that fit into the pin holes in the coupling plates are not press-fitted but instead gaps remain, grease escapes through the gaps. As a result, in the case of this type of sealed chain, the connecting structure must be one in which a special connection/cutting apparatus is used to press-fit the coupling pins. Moreover, to prevent the seal ring that is sandwiched between the inner plat and the outer plate from being compressed excessively, the coupling pins are provided with steps. Then, when lightly press-fitted into the coupling plate, a clip is also installed so that the coupling plate does not get detached.

FIG. 7 shows how to connect a conventional sealed chain, in which (a) shows the coupling pin (i) and the coupling plate (j), with a tip portion of the coupling pin (i) having a stepped tip portion (k) of slightly reduced diameter, and further a clip groove (m) that the clip (h) engages provided at the tip, and (b) shows an instance in which the coupling plate (j) engages the stepped tip portion (k) of the coupling pin (i), with a special tool (n) used to fit the stepped tip portion (k) to the hole (i) of the coupling plate (j).

Although the tip portion of the coupling pin (i) is stepped and therefore comparatively easy to fit, an ordinary tool cannot be used for the coupling plate (j) because it is installed by press-fitting. In this case, a seal ring (o) is interposed between the inner plate (c) of the inner link (a) and the coupling plate (j). FIG. 7(c) shows the clip (h) installed so as to prevent the press-fitted coupling plate (j) from detaching. Although the coupling plate (j) is installed by press-fitting, the press-fitting is a light one sufficient merely to prevent the grease from escaping, with the coupling plate (j) prevented from detaching by the clip (h).

### SUMMARY OF THE INVENTION

Thus the joint structure of the sealed chain has the problems described above. It is these problems that the present invention attempts to solve, providing a sealed chain joint structure the coupling plate of which can be installed easily using ordinary tools, without using special tools for the coupling pins of the coupling links and press-fitting the coupling plate.

The sealed chain joint structure of the present invention connects an inner link and a coupling link that corresponds to an outer link, in which two coupling pins project from an outer plate and the coupling plate is installed on the two coupling pins using ordinary tools. Therefore, the coupling pins can be easily fitted to holes (pin holes) provided in the connecting plate. Here, the coupling pins are formed as stepped pins, in which a step is provided on a tip of the coupling pin, and moreover, a clip groove that a clip engages is provided on the tip of the coupling pin.

Then, a ring groove is formed on the stepped tip portion of lesser diameter due to the step described above, and a seal ring is fitted to the ring groove and installed thereby. If the coupling plate is then installed on the stepped tip portion, the seal ring can contact the inner surface of the pin hole in the coupling plate and can cover the gap between that inner surface and the coupling pin. Incidentally, since this is a sealed chain, the seal ring, which is installed concentrically about the pin, is interposed between the inner plate and the outer plate, thus preventing the grease that fills the bush hole from escaping.

At the same time, in the present invention the coupling pins of the coupling link described above may also be constructed as straight pins instead of stepped pins. Using a stepped pin positions the coupling plate when press-fitting and mounting it, in an effort to prevent the seal ring interposed between the inner and outer plates from being crushed. However, if the bush is made long and constructed so as to project from the inner plate of the inner link, the gap between the inner and outer plates becomes uniform and the seal ring can be protected from excessive compression. A similar ring groove is then formed in the tip portion of the step-less, straight coupling pin and the seal ring fitted thereto.

Although the coupling plate described above is held in place by a clip so that it does not get detached from the coupling pins, as holding means the coupling plate may be held in place by a screw or a pin. Specifically, forming the tip of the coupling pin into a screw and engaging a nut to that screw holds the coupling plate in place so that it does not get detached. Alternatively, a stop hole may be provided in the tip of the coupling pin so as to penetrate the coupling pin, and a cotter pin installed in that stop hole so as to prevent the coupling plate from detaching.

The sealed chain of the present invention provides a ring groove on the tip portion of either a stepped tip portion coupling pin or a straight coupling pin and fits the seal ring to the ring groove. Therefore, when the coupling plate is installed on the tip portion of the coupling pin, the aforementioned seal ring doses the clearance (gap) between the pin and the coupling plate, thus preventing the grease filled the bush hole from escaping. Sealing the pin tip portion with a separate seal ring eliminates the need to press-fit the coupling plate onto the tip portion of the coupling pins, and as a result, the coupling plate can be installed and the work of connecting the sealed chain can be performed using ordinary tools instead of special tools.

### BRIEF DESCRIPTION OF THE DRAWINGS

FIGS. 1A and 1B show plan and side views, respectively, of a sealed chain according to an embodiment of the present invention;

FIG. 2 shows a development plan view of a joint structure of the sealed chain;

FIG. 3 shows steps in a process of assembling the joint structure;

FIG. 4 shows a plan sectional view of the joint structure of the sealed chain;

FIGS. 5A and 5B show plan and side views, respectively of a roller chain according to a conventional example;

FIG. 6 shows plan and side views, respectively of a coupling portion of a roller chain according to a conventional example using a clip; and

FIG. 7 shows joint structure assembly steps according to a conventional example in which a coupling plate is press-fitted and installed.

### DETAILED DESCRIPTION OF THE PREFERRED EMBODIMENTS

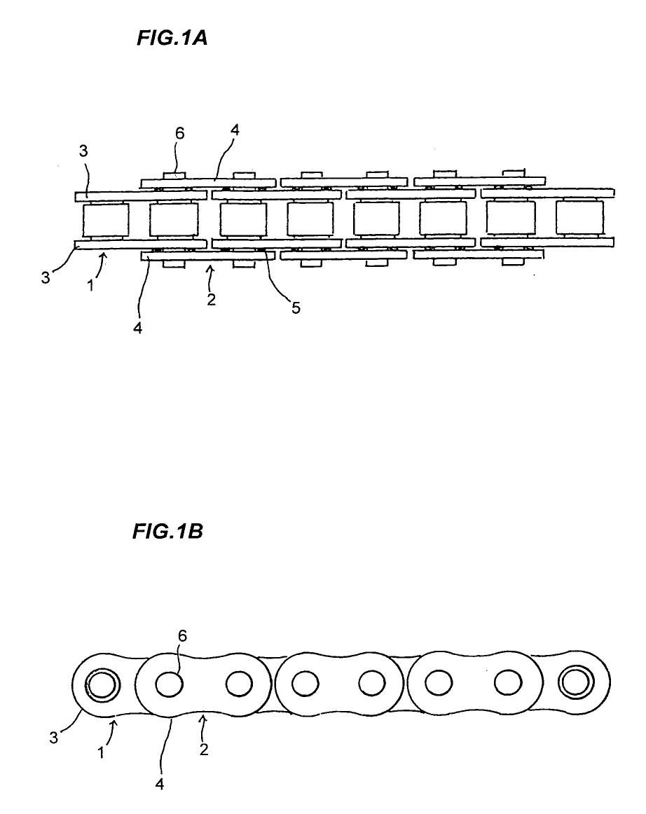

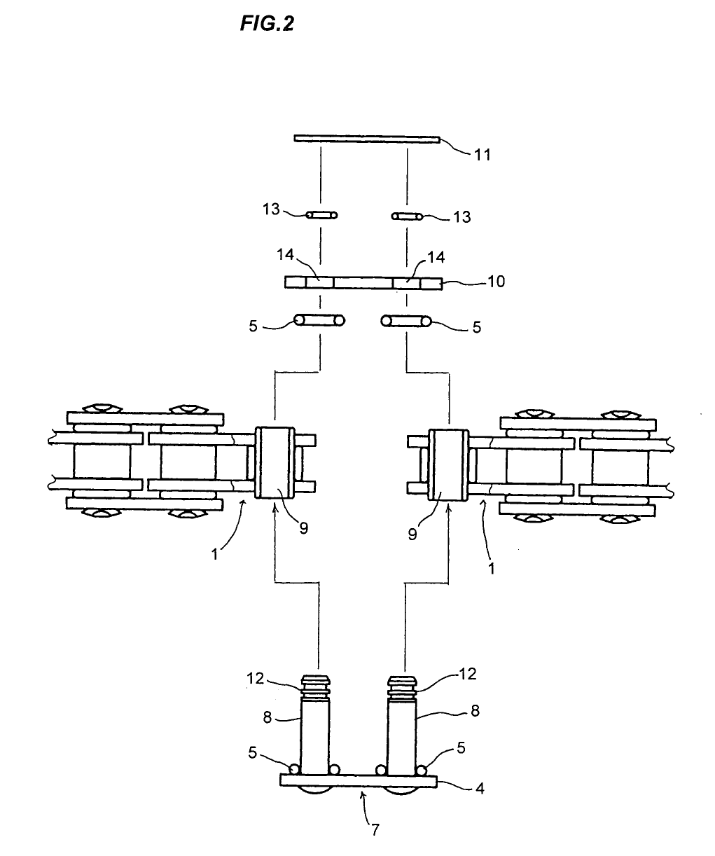

FIGS. 1A and 1B show an embodiment of a sealed chain, the basic structure of which is the same as that of the roller chain shown in the drawings described above. Specifically, inner links 1, 1 . . . and outer links 2, 2 . . . are pivotally connected one another and a seal ring 5 is interposed between an inner plate 3 of the inner link 1 and an outer plate 4 of the outer link 2. Therefore, in the assembly of the chain, a bush hole in the inner link 1 is filled with grease and in this state a pin 6 of the outer link 2 is inserted therein and the seal ring 5, which is fitted to the pin 6, is interposed between the inner plate 3 and the outer plate 4, thereby preventing the grease from escaping.

When connecting the two ends of the sealed chain so as to make the chain endless, as with an ordinary roller chain a coupling link is used and both inner links 3, 3 are tied together. FIG. 2 shows a development view of the general outlines of the joint structure that connects the sealed chain. The two inner links 1, 1 are joined together by a coupling link 7, with two coupling pins 8, 8 projecting from the outer plate 4. The two coupling pins 8, 8 are inserted into bush holes 9, 9 in the inner links 1, 1 at both ends. A coupling plate 10 is installed on the tips of the coupling pins 8, 8 that protrude from the opposite side of the inner links 1, 1. Further, a clip 11 is mounted on the tips of the coupling pins 8, 8 and the coupling plate 10 is fixedly mounted in place so that it does not get detached.

In this case, since the seal ring 5 is also used for the connecting part as well, seal rings 5, 5 are fitted to the coupling pins 8, 8 even when seal rings 5, 5 are installed on proximal portions of the coupling pins 8, 8 that comprise the coupling link 7 and the coupling plate 10 installed. Therefore, seals 5, 5 are interposed between the inner plates 3, 3 of the inner link 1 and between the outer plate 4 of the coupling link 7 and the coupling plate 10 and sealed.

Further, in the present invention small seal rings 13, 13 may also be installed on the stepped tip portions 12, 12 of the coupling pins 8, 8 as well, enabling the clearances between the coupling plate 10 holes 14, 14 and the stepped tip portions 12, 12 to be filled in. Therefore, escape of the grease that fills the bush holes 9, 9 from the holes 14, 14 in the coupling plate 10 installed on the stepped tip portions 12,12 can be prevented.

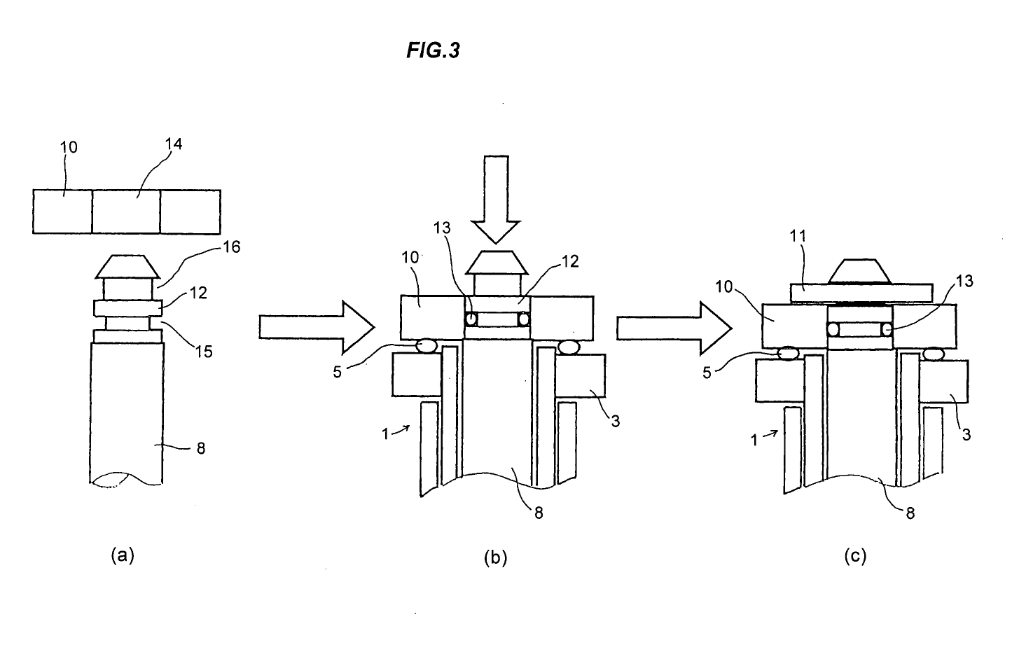

FIG. 3 shows an enlarged view of the joint structure according to the present invention, in which (a) shows the tip portion of the coupling pin 8 and the coupling plate 10. The tip portion of the coupling pin 8 is formed as a stepped tip portion 12 of slightly reduced diameter. A ring groove 15 is provided on the stepped tip portion 12. The tip of the stepped tip portion 12 is also provided with a clip groove 16 that a clip engages. The diameter of the stepped tip portion 12 described above is slightly smaller than that of the coupling pin 8, and therefore the coupling plate 10 is not forcibly press-fit but instead is installed so as to leave a slight clearance. Therefore, the installation of the coupling plate 10 can be accomplished using ordinary tools.

FIG. 3(b) shows the coupling plate 10 installed on the stepped tip portion 12 of the coupling pin 8 that projects from the inner link 1 as the coupling pin 8 passes through the bush hole 9 in the inner link 1. The seal ring 5 is interposed between the inner plate 3 of the inner link 1 and the coupling plate 10, and a small seal ring 13 is fitted to the ring groove 15 in the stepped tip portion 12. Therefore, even when a slight clearance exists between the stepped tip portion 12 and the coupling plate 10, grease does not escape from such clearance. Of course, since the seal ring 5 is interposed between the inner plate 3 and the coupling plate 10, grease does not escape from between these two plates.

FIG. 3(c) shows the clip 11 mounted on the tip of the coupling pin 8. The stepped tip portion 12 of the coupling pin 8, as shown in step (a), is of slightly reduced diameter, and the ring groove 15 is formed around the outer periphery. A clip groove 16 is provided at the tip of the stepped tip portion 12. The clip 11 engages the clip groove 16 and is installed thereat, thus ensuring that the coupling plate 10 installed on the stepped tip portion 12 does not get detached.

The joint structure of the present invention is constructed as shown in FIG. 3(c). The seal ring 13 is fitted to the ring groove 15 in the stepped tip portion 12 and the stepped tip portion 12 is fitted to the hole 14 in the coupling plate 10 and installed. There is a slight clearance between the stepped tip portion 12 and the hole 14 in the coupling plate 10, and as a result the coupling plate 10 can be installed without using special tools. At the same time, this clearance is covered by the seal ring 13, and thus there is no escape of the grease filled the bush hole 9 in the inner link 1.

Although there is some risk of the coupling plate 10 getting detached because it is not forcibly press-fitted into place, the clip 11 is installed on the outside thereof in order to prevent that detachment. The clip 11 engages the clip groove 16 formed in the stepped tip portion 12 and is installed.

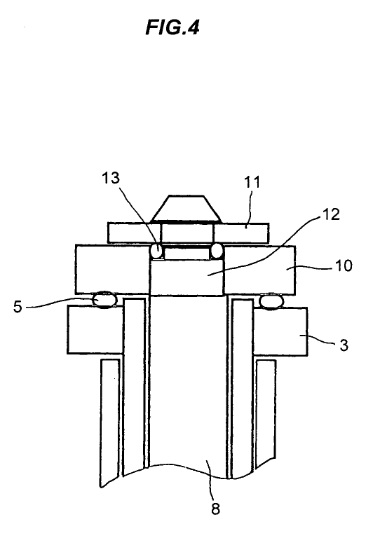

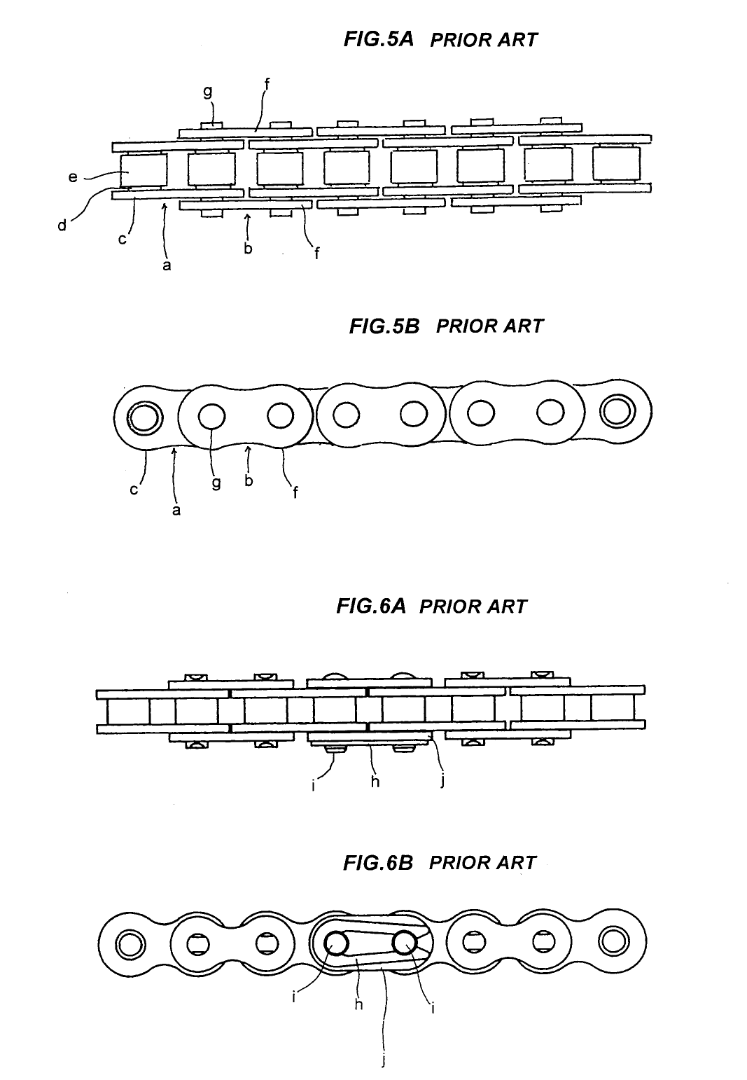

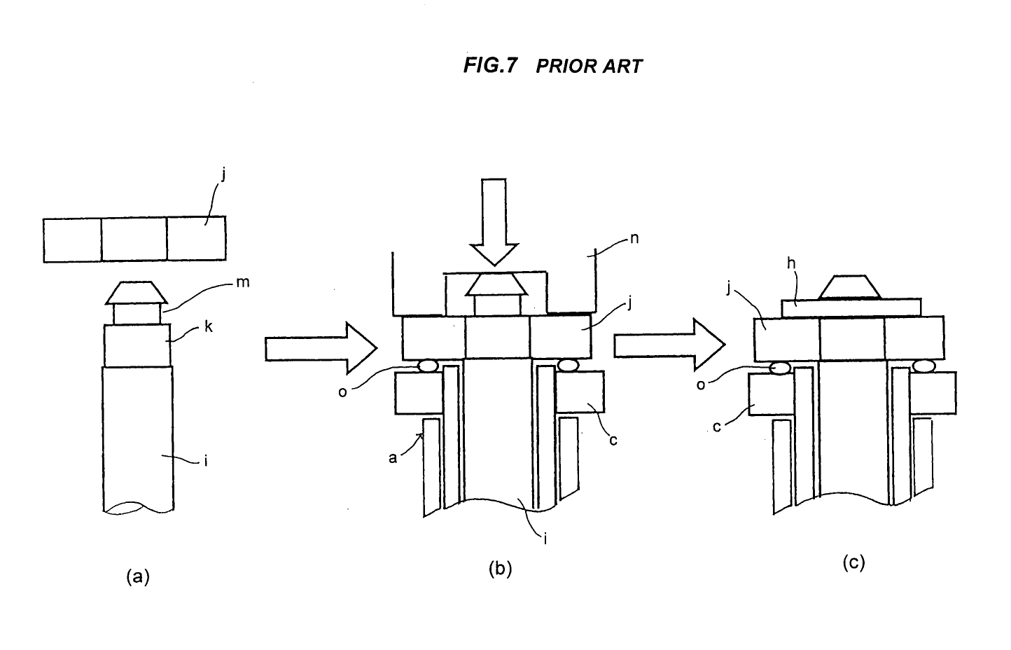

Although in the embodiment described above the ring groove 15 is provided substantially at the center of the stepped tip portion 12 of the coupling pin 8, in the present invention the ring groove 15 is not particularly limited to that location. It is sufficient that the structure be such that, by press-fitting the stepped tip portion 12 into the hole 14 in the coupling plate 10, the clearance can be covered. Thus, as shown in FIG. 4, the ring groove 15 may be provided at a location at which the seal ring 13 contacts the clip 11.

1. A sealed chain joint structure that connects both ends of a sealed chain by fitting a seal ring concentrically around a pin in a gap formed between an inner plate of an inner link and an outer plate of an outer link comprising:
a coupling link that joins together inner links of said both ends,
a coupling pin that passes through a bush hole and projects from said outer plate, a tip portion of said coupling pin being a stepped tip portion of reduced diameter,
a ring groove formed in an outer periphery of said stepped tip portion,
a separate seal ring fitted to said ring groove,
wherein said stepped tip portion protruding from an opposite side of said inner link inserted into a hole and said coupling plate mounted,
and further, holding means such as a clip or the like engaging a tip of said stepped tip portion and mounted.

2. The sealed chain joint structure according to claim 1, wherein said ring groove is provided at a center portion of said stepped tip portion.

3. The sealed chain joint structure according to claim 1, wherein said ring groove is provided at a location at which a distal end side of said stepped tip portion contacts said clip.

4. The sealed chain joint structure according to claim 1, wherein said ring groove is provided at a proximal end side of said stepped tip portion.

5. A sealed chain joint structure that connects both ends of a sealed chain by fitting a seal ring concentrically around a pin in a gap formed between an inner plate of an inner link and an outer plate of an outer link comprising:
a coupling link that joins together inner links of said both ends,
a coupling pin that passes through a bush hole and projects from said outer plate, a ring groove formed in an outer periphery of a tip portion of said coupling pin,
a separate seal ring fitted to said ring groove,
wherein said tip portion of said coupling pin protruding from an opposite side of said inner link inserted into a hole so as to mount a coupling plate,
said seal ring sealing a gap between said hole in said coupling plate hole and said coupling pin,
and further, holding means such as a clip or the like engaging said tip of said coupling pin and mounted.

6. The sealed chain joint structure according to claim 1, wherein said holding means comprises a nut engaging said tip of said coupling pin, thereby holding said coupling plate by the nut.

7. The sealed chain joint structure according to claim 1, wherein said holding means comprises a cotter pin mounted in a stop hole provided in said tip of said coupling pin, thereby holding said coupling plate in place.

8. The sealed chain joint structure according to claim 1, wherein said holding means comprises a spring pin fitted in a stop hole provided in said tip of said coupling pin, thereby holding said coupling plate in place.

9. The sealed chain joint structure according to claim 2, wherein said holding means comprises a nut engaging said tip of said coupling pin, thereby holding said coupling plate by the nut.

10. The sealed chain joint structure according to claim 3, wherein said holding means comprises a nut engaging said tip of said coupling pin, thereby holding said coupling plate by the nut.

11. The sealed chain joint structure according to claim 4, wherein said holding means comprises a nut engaging said tip of said coupling pin, thereby holding said coupling plate by the nut.

12. The sealed chain joint structure according to claim 5, wherein said holding means comprises a nut engaging said tip of said coupling pin, thereby holding said coupling plate by the nut.

13. The sealed chain joint structure according to claim 2, wherein said holding means comprises a cotter pin mounted in a stop hole provided in said tip of said coupling pin, thereby holding said coupling plate in place.

14. The sealed chain joint structure according to claim 3, wherein said holding means comprises a cotter pin mounted in a stop hole provided in said tip of said coupling pin, thereby holding said coupling plate in place.

15. The sealed chain joint structure according to claim 4, wherein said holding means comprises a cotter pin mounted in a stop hole provided in said tip of said coupling pin, thereby holding said coupling plate in place.

16. The sealed chain joint structure according to claim 5, wherein said holding means comprises a cotter pin mounted in a stop hole provided in said tip of said coupling pin, thereby holding said coupling plate in place.

17. The sealed chain joint structure according to claim 2, wherein said holding means comprises a spring pin fitted in a stop hole provided in said tip of said coupling pin, thereby holding said coupling plate in place.

18. The sealed chain joint structure according to claim 3, wherein said holding means comprises a spring pin fitted in a stop hole provided in said tip of said coupling pin, thereby holding said coupling plate in place.

19. The sealed chain joint structure according to claim 4, wherein said holding means comprises a spring pin fitted in a stop hole provided in said tip of said coupling pin, thereby holding said coupling plate in place.

20. The sealed chain joint structure according to claim 5, wherein said holding means comprises a spring pin fitted in a stop hole provided in said tip of said coupling pin, thereby holding said coupling plate in place.
